(19) United States
(12) Patent Application Publication
(10) Pub. No.: US 2025/0249838 A1
(43) Pub. Date: Aug. 7, 2025

(54) FISHING ROD HOLDER FOR A VEHICLE

(71) Applicants: Frank Billbrough, JR., Lincoln, DE (US); Frank Billbrough, SR., Lincoln, DE (US)

(72) Inventors: Frank Billbrough, JR., Lincoln, DE (US); Frank Billbrough, SR., Lincoln, DE (US)

(21) Appl. No.: 18/430,062

(22) Filed: Feb. 1, 2024

(51) Int. Cl. B60R 9/08

(52) U.S. Cl. CPC B60R 9/08

(57) ABSTRACT

A fishing rod holder apparatus for securing a fishing rod to a vehicle includes a bracket and a rod receiver. The bracket is shaped to position a handle of the fishing rod above and laterally offset from a hood of the vehicle. The rod receiver is shaped and oriented to hold the handle and orient the fishing rod to extend upwardly and rearwardly from the rod receiver with respect to the vehicle. The bracket is adapted to receive existing fasteners of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing rod holders and more particularly pertains to a new fishing rod holder for securing a fishing rod to a vehicle.

### (2) Description of Related Art Including Information Disclosed Under 37 CFR 1.97 and 1.98

The prior art describes various means of mounting fishing rods to vehicles for storage, transportation, and use while fishing. However, the prior art fails to describe such an apparatus which mounts near a front of a vehicle such that the fishing rod is oriented to extend upwardly and rearwardly from the mounting point and which attaches to a body of the vehicle between the body and a hood closure.

### BRIEF SUMMARY OF THE INVENTION

An embodiment of the disclosure meets the needs presented above by generally comprising a bracket having a vehicle mount portion, a rod mount portion, and an intermediate portion. The intermediate portion is coupled to and extends between the vehicle mount portion and the rod mount portion. The rod mount portion is spaced laterally with respect to the vehicle mount portion from the vehicle mount portion, and a top edge of the rod mount portion is spaced upwardly from the vehicle mount portion. The vehicle mount portion is configured to mount to a vehicle body. A rod receiver is coupled to the rod mount portion of the bracket adjacent to the top edge. The rod receiver has a tube shape and is elongated between a first end and a second end. The rod receiver is open at the first end and is sized and configured to receive a handle of a fishing rod through the first end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fishing rod holder apparatus according to an embodiment of the disclosure.

FIG. 2 is a front view of an embodiment of the disclosure.

FIG. 3 is a first side view of an embodiment of the disclosure.

FIG. 4 is a second side view of an embodiment of the disclosure.

FIG. 5 is an in-use view of an embodiment of the disclosure.

FIG. 6 is a rear detail in-use view of an embodiment of the disclosure.

FIG. 7 is a perspective view of an embodiment of the disclosure.

FIG. 8 is a rear view of an embodiment of the disclosure.

FIG. 9 is a front detail in-use view of an embodiment of the disclosure.

### DETAILED DESCRIPTION OF THE INVENTION

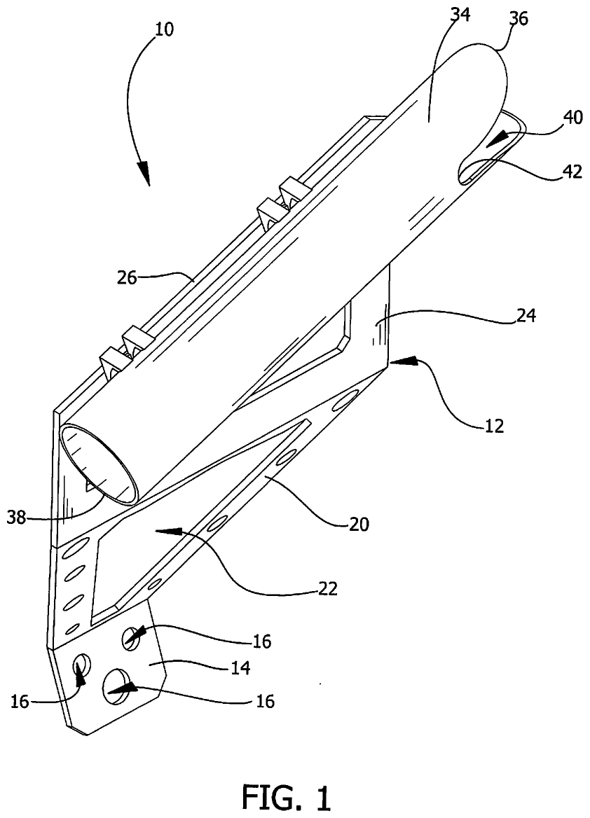

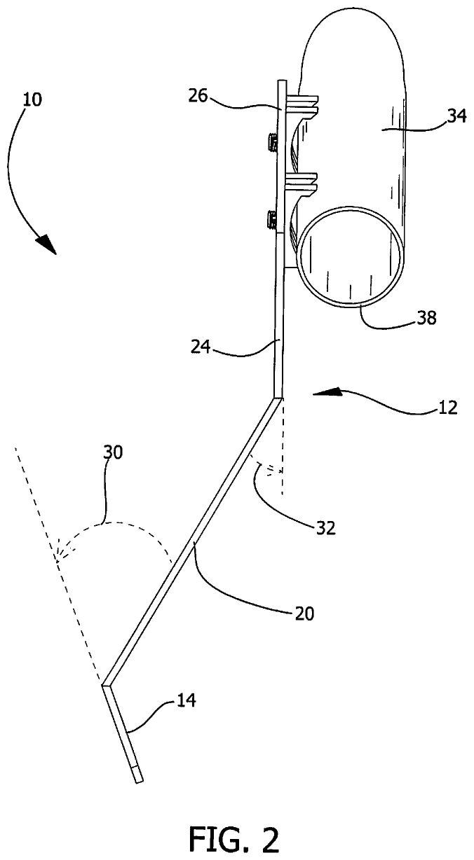

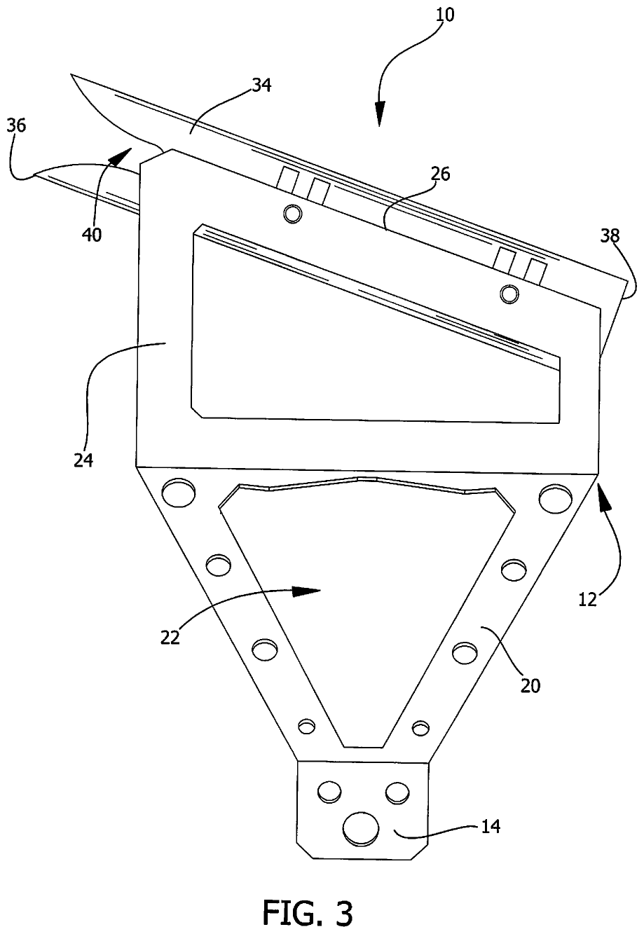

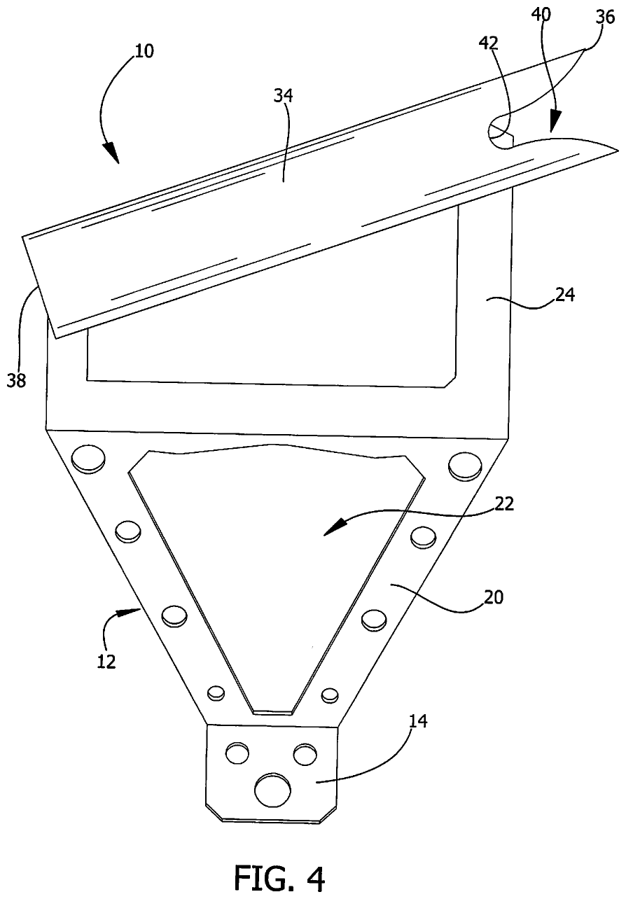

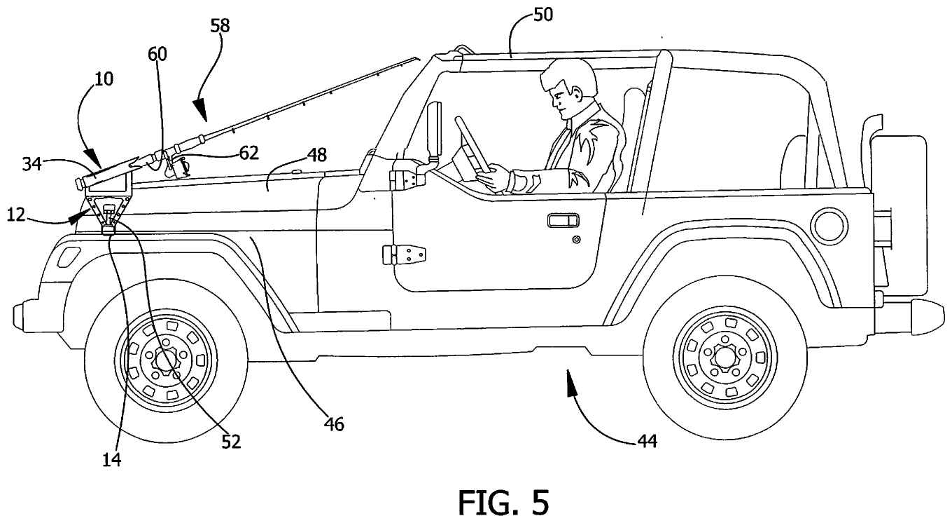

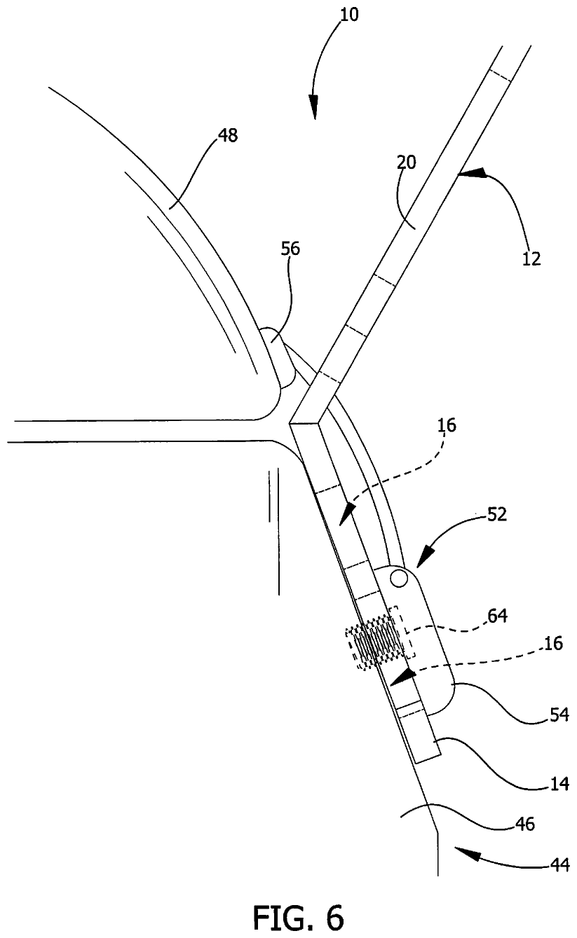

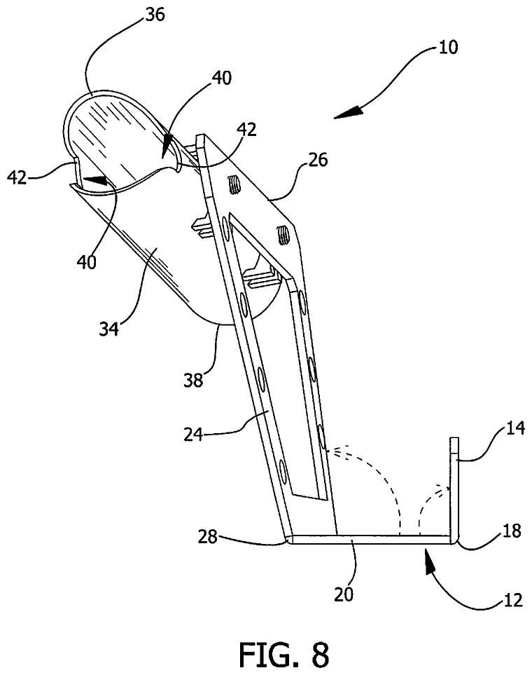

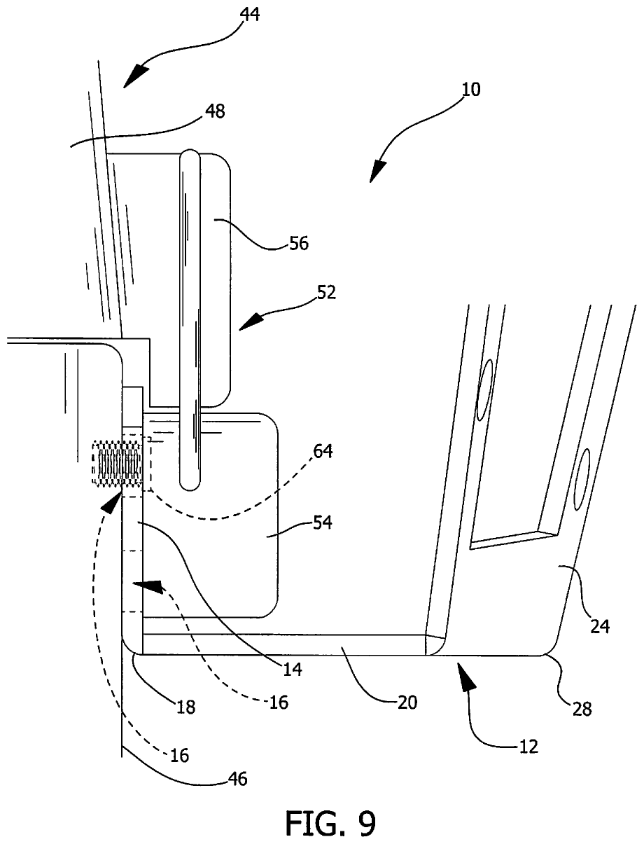

With reference now to the drawings, and in particular to FIGS. 1 through 9 thereof, a new fishing rod holder embodying the principles and concepts of an embodiment of the disclosure and generally designated by the reference numeral 10 will be described.

As best illustrated in FIGS. 1 through 9, the fishing rod holder apparatus 10 generally comprises a bracket 12 adapted to mount to a vehicle body 44 and a rod receiver 34 coupled to the bracket 12. The bracket 12 mounts to a side of the vehicle body 44 near a front end of the vehicle body 44 and near but separate from a hood panel 48 of the vehicle body 44. The rod receiver 34 is shaped to hold onto a handle 60 of a fishing rod 58 and positioned such that the fishing rod 58 extends upwardly and rearwardly with respect to the vehicle body 44 when held by the rod receiver 34. The fishing rod 58 is oriented by the rod receiver 34 to avoid interference with a cabin portion 50 of the vehicle body 44.

The vehicle body 44 comprises a main portion 46 and a hood panel 48, wherein the hood panel 48 is pivotably mounted to the main portion 46. A hood closure 52 is operable to secure the hood panel 48 in a closed position with respect to the main portion 46 and includes a first mating member 54 and a second mating member 56. The first mating member 54 is mounted to the main portion 46, and the second mating member 56 is mounted to the hood panel 48. The hood closure 52 is depicted as a latch in the Figures but may comprise a clip, a snap connector, or any other suitable fastener. The bracket 12 is adapted to mount between the first mating member 54 of the hood closure 52 and the main portion 46 of the vehicle body 44.

The bracket 12 comprises a vehicle mount portion 14, a rod mount portion 24, and an intermediate portion 20. The vehicle mount portion 14 is mounted to the vehicle body 44 between the main portion 46 and the first mating member 54 of the hood closure 52. A threaded fastener 64 extends through one of a plurality of mounting holes 16 that extend through the vehicle mount portion 14 to mount the first mating member 54 of the hood closure 52 and the bracket 12 to the main portion 46 of the vehicle body 44. In other embodiments, further fasteners may be used, or the first mating member 54 and the bracket 12 may be integrally formed or otherwise coupled to the vehicle body 44 via any suitable means.

The intermediate portion 20 is coupled to and extends between the vehicle mount portion 14 and the rod mount portion 24. The rod mount portion 24 is spaced laterally with respect to the vehicle mount portion 14 from the vehicle mount portion 14, and a top edge 26 of the rod mount portion 24 is spaced upwardly from the vehicle mount portion 14. The rod receiver 34 coupled to the rod mount portion 24 of the bracket 12 adjacent to the top edge 26. The rod receiver 34 has a tube shape and is elongated between a first end 36 and a second end 38. The rod receiver 34 is open at the first end 36 and the second end 38. The rod receiver 34 is sized and configured to receive a handle 60 of a fishing rod 58 through the first end 36. The rod receiver 34 is oriented to extend upwardly and rearwardly with respect to the bracket 12 from the second end 38 to the first end 36. The rod receiver 34 is also oriented to lie parallel to a vertical longitudinal plane of the vehicle body 44 when the bracket 12 is mounted to the vehicle body 44.

The rod receiver 34 also defines slots 40 which extends from the first end 36 toward the second end 38. The slots 40 are open at the first end 36 and terminate at a closed end 42. The slots 40 are in communication with an interior of the rod receiver 34 and are sized and configured to accommodate a reel mount 62 of the fishing rod 58.

FIGS. 1 through 6 depict a first embodiment of the disclosure. In this embodiment, each of the vehicle mount portion 14, the rod mount portion 24, and the intermediate portion 20 has a substantially planar shape. The vehicle mount portion 14 lies on a vehicle mount plane, the intermediate portion 20 lies on an intermediate plane, the rod mount portion 24 lies on a rod mount plane. The intermediate portion 20 of the bracket 12 extends upwardly and laterally away from the vehicle mount portion 14 with respect to the vehicle mount portion 14. The rod mount portion 24 extends further upwardly from the intermediate portion 20 with respect to the vehicle mount portion 14. An acute angle 30 between the vehicle mount plane and the intermediate plane is greater than an acute angle 32 between the rod mount plane and the intermediate plane. For example, the acute angle 30 between the vehicle mount plane and the intermediate plane may be about 30.0 degrees and the acute angle 32 between the rod mount plane and the intermediate plane may be about 10.0 degrees. The acute angles 30, 32 are adapted to set the orientation of the rod receiver 34 as described above. The intermediate portion 20 of this embodiment defines an opening 22 which is sized and configured to permit the hood closure 52 of the vehicle body 44 to extend therethrough.

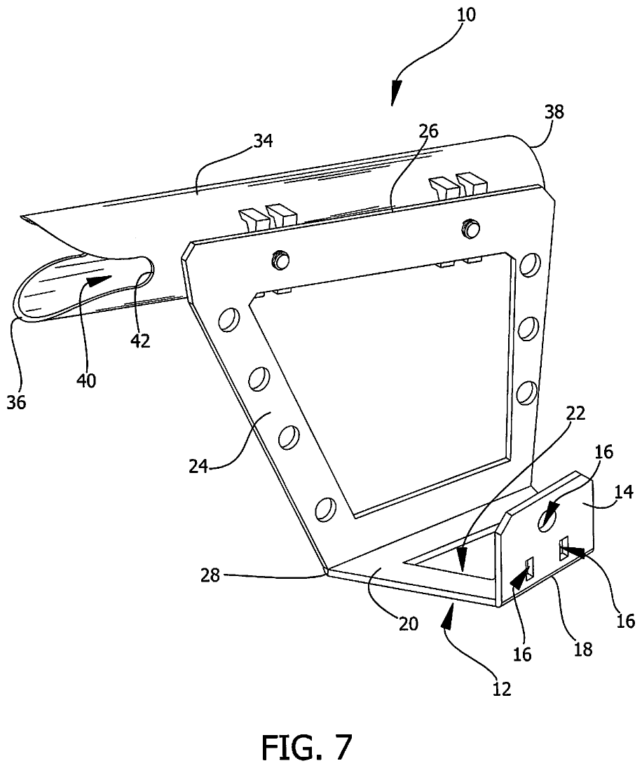

FIGS. 7 through 9 depict a second embodiment of the disclosure in which each of the vehicle mount portion 14, the rod mount portion 24, and the intermediate portion 20 are planar as in the first embodiment. However, the intermediate portion 20 of this embodiment extends between a lower edge 18 of the vehicle mount portion 14 and a bottom edge 28 of the rod mount portion 24 such that the bracket 12 forms a U-shape. In this manner, the bracket 12 extends below and around the first mating member 54 of the hood closure 52 when mounted to the vehicle body 44. The rod mount plane forms oblique angles with the vehicle mount plane and the intermediate plane. The oblique angles are sized to orient the rod receiver 34 as described above. In other embodiments, the right angles may be used if sufficient to achieve the desired orientation of the rod receiver 34.

In use, the bracket 12 is attached to the vehicle as described above. The handle 60 of the fishing rod 58 is inserted into the rod receiver 34 to carry the fishing rod 58 on the vehicle body 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing rod holder apparatus comprising:
a bracket comprising a vehicle mount portion, a rod mount portion, and an intermediate portion, the intermediate portion being coupled to and extending between the vehicle mount portion and the rod mount portion, the rod mount portion being spaced laterally with respect to the vehicle mount portion from the vehicle mount portion, a top edge of the rod mount portion being spaced upwardly from the vehicle mount portion, the vehicle mount portion being configured to mount to a vehicle body; and
a rod receiver coupled to the rod mount portion of the bracket adjacent to the top edge, the rod receiver having a tube shape and being elongated between a first end and a second end, the rod receiver being open at the first end, the rod receiver being sized and configured to receive a handle of a fishing rod through the first end.

2. The apparatus of claim 1, wherein each of the vehicle mount portion, the rod mount portion, and the intermediate portion has a substantially planar shape.

3. The apparatus of claim 1, wherein the vehicle mount portion defines a mounting hole configured to facilitate mounting the bracket to the vehicle body via a threaded fastener.

4. The apparatus of claim 1, wherein the rod receiver is oriented to extend upwardly and rearwardly with respect to the bracket from the second end to the first end.

5. The apparatus of claim 1, wherein the rod receiver is oriented and configured to lie parallel to a vertical longitudinal plane of the vehicle body when the bracket is mounted to the vehicle body.

6. The apparatus of claim 1, wherein the rod receiver defines a slot which extends from the first end toward the second end, the slot being open at the first end and terminating at a closed end, the slot being in communication with an interior of the rod receiver, the slot being sized and configured to accommodate a reel mount of the fishing rod.

7. The apparatus of claim 1, wherein the intermediate portion of the bracket extends upwardly and laterally away from the vehicle mount portion with respect to the vehicle mount portion, the rod mount portion extending upwardly from the intermediate portion with respect to the vehicle mount portion, each of the vehicle mount portion, the rod mount portion, and the intermediate portion having substantially planar shapes, the vehicle mount portion lying on a vehicle mount plane, the intermediate portion lying on an intermediate plane, the rod mount portion lying on a rod mount plane.

8. The apparatus of claim 7, wherein an acute angle between the vehicle mount plane and the intermediate plane is greater than an acute angle between the rod mount plane and the intermediate plane.

9. The apparatus of claim 7, wherein the intermediate portion defines an opening sized and configured to permit a hood closure of the vehicle body to extend therethrough.

10. The apparatus of claim 1, wherein each of the vehicle mount portion, the rod mount portion, and the intermediate portion has a substantially planar shape, the intermediate portion of the bracket extending between a lower edge of the vehicle mount portion and a bottom edge of the rod mount portion, the vehicle mount portion lying on a vehicle mount plane, the intermediate portion lying on an intermediate plane, the rod mount portion lying on a rod mount plane, the rod mount plane forming oblique angles with each of the vehicle mount plane and the intermediate plane.

11. A fishing rod holder system comprising:
a vehicle body comprising a main portion and a hood panel, the hood panel being pivotably mounted to the main portion, the vehicle body comprising a hood closure which is operable to secure the hood panel in a closed position with respect to the main portion, the hood closure comprising a first mating member and a second mating member, the first mating member being mounted to the main portion, the second mating member being mounted to the hood panel;
a bracket being mounted to the vehicle body, the bracket comprising a vehicle mount portion, a rod mount portion, and an intermediate portion, the vehicle mount portion being mounted to the vehicle body between the main portion and the first mating member of the hood closure, the intermediate portion being coupled to and extending between the vehicle mount portion and the rod mount portion, the rod mount portion being spaced laterally with respect to the vehicle mount portion from the vehicle mount portion, a top edge of the rod mount portion being spaced upwardly from the vehicle mount portion; and
a rod receiver coupled to the rod mount portion of the bracket adjacent to the top edge, the rod receiver having a tube shape and being elongated between a first end and a second end, the rod receiver being open at the first end, the rod receiver being sized and configured to receive a handle of a fishing rod through the first end.

12. The system of claim 11, wherein the vehicle mount portion defines a mounting hole which extends therethrough, further comprising a threaded fastener extending through the mounting hole of the vehicle mount portion of the bracket, the threaded fastener fastening together the first mating member of the hood closure, the bracket, and the main portion of the vehicle body.

13. The system of claim 11, wherein the rod receiver is oriented to extend upwardly and rearwardly with respect to the bracket from the second end to the first end.

14. The system of claim 11, wherein the rod receiver is oriented to lie parallel to a vertical longitudinal plane of the vehicle body when the bracket is mounted to the vehicle body.

15. The system of claim 11, wherein each of the vehicle mount portion, the rod mount portion, and the intermediate portion has a substantially planar shape, the intermediate portion of the bracket extending upwardly and laterally away from the vehicle mount portion with respect to the vehicle mount portion, the rod mount portion extending upwardly from the intermediate portion with respect to the vehicle mount portion, the vehicle mount portion lying on a vehicle mount plane, the intermediate portion lying on an intermediate plane, the rod mount portion lying on a rod mount plane.

16. The system of claim 15, wherein an acute angle between the vehicle mount plane and the intermediate plane being greater than an acute angle between the rod mount plane and the intermediate plane.

17. The system of claim 15, wherein the intermediate portion defines an opening sized and configured to permit the hood closure of the vehicle body to extend therethrough.

18. The system of claim 11, wherein each of the vehicle mount portion, the rod mount portion, and the intermediate portion has a substantially planar shape, the intermediate portion of the bracket extending between a lower edge of the vehicle mount portion and a bottom edge of the rod mount portion, the vehicle mount portion lying on a vehicle mount plane, the intermediate portion lying on an intermediate plane, the rod mount portion lying on a rod mount plane.

19. The system of claim 18, wherein the rod mount plane forms an oblique angle with the vehicle mount plane.

20. The system of claim 18, wherein the rod mount plane forms an oblique angle with the intermediate plane.
